(19) United States
(12) Patent Application Publication
(10) Pub. No.: US 2002/0076070 A1
(43) Pub. Date: Jun. 20, 2002

(54) Speaker

(75) Inventors: Takamasa Yoshikawa, Saitama (JP); Kiyohide Ogasawara, Saitama (JP); Hideo Satoh, Saitama (JP); Atsushi Yoshizawa, Saitama (JP); Shingo Iwasaki, Saitama (JP); Nobuyasu Negishi, Saitama (JP); Takashi Yamada, Saitama (JP); Takashi Chuman, Saitama (JP); Kazuto Sakemura, Saitama (JP); Takuya Hata, Saitama (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: PIONEER CORPORATION

(21) Appl. No.: 10/011,770

(22) Filed: Dec. 11, 2001

(30) Foreign Application Priority Data
Dec. 15, 2000 (JP) P.2000-381409

(51) Int. Cl. H04R 25/00

(52) U.S. Cl. 381/191

(57) ABSTRACT

A speaker includes a silicone wafer 1, a thermal barrier layer 2 formed by anodizing a part of the silicone wafer 1, and an exothermic electrode 3 made of aluminum formed on the thermal barrier layer 2.

### BACKGROUND OF THE INVENTION

1. Field of the Invention

The present invention relates to a speaker useful for the audio equipment, and more particularly to a speaker.

2. Description of the Related Art

An electro-acoustic transducer is well known in which an alternating current is introduced into a gold foil with only both ends fixed. If an alternating current is passed into the gold foil, the temperature of the gold foil changes, thereby causing a compression or expansion of the air nearby to produce an acoustic pressure.

However, the gold foil for use is so thin as to fabricate and handle with difficulties, and is restricted in the input power, whereby a speaker is difficult to produce a sufficient sound volume.

### SUMMARY OF THE INVENTION

It is an object of this invention to provide a speaker that can be easily handled and can produce a sufficient sound volume.

The present invention provides a speaker comprising a substrate, a thermal barrier layer formed on the substrate, and an exothermic electrode formed on the thermal barrier layer.

This speaker can be easily handled because the exothermic electrode is fixed to the substrate, and can produce a large sound volume, because a heat not converted into the sound wave is radiated via the substrate and a large power can be input into the exothermic electrode. Owing to the use of the joule heating, the high acoustic efficiency can be attained, and the generated frequency band is broad. Further, the entire apparatus can be reduced in size, weight, and thickness. Further, the conformation of the exothermic electrode can be varied in arbitrary manner by changing the shape of the substrate, thereby controlling the directivity of generated sound wave at will.

The thermal barrier layer may be formed by anodizing a part of the substrate. In this case, the normal semiconductor process may be utilized.

The thermal barrier layer may be formed by supplying a material making up the thermal barrier layer on the substrate. In this case, the thermal barrier layer can be made of a material selected from a wide range of materials.

The substrate may be made of silicone. In this case, the normal semiconductor process may be utilized The speaker may further comprise an acoustic horn for transmitting a sound wave arising in the vicinity of the exothermic electrode. In this case, because the acoustic horn can adjust the transmission characteristic, the speaker can achieve the desired characteristics by increasing the sound pressure level in a low frequency band, for example.

The surface of the exothermic electrode may be formed in a planar shape. In this case, the speaker can be adjusted to have a narrower directivity.

The surface of the exothermic electrode may be formed in a curved shape. In this case, the speaker can be afforded with a wider directivity than when the exothermic electrode is formed in planar shape.

The surface of the exothermic electrode may be formed in a shape of constituting at least a part of sphere. In this case, the speaker can be afforded with a wider directivity than when the exothermic electrode is formed in planar shape. Also, the surface of the exothermic electrode is formed according to an almost spherical shape, whereby the speaker can have a non-directivity of radiating sound wave uniformly in substantially all directions.

For an easy understanding of this invention, reference numerals employed in the accompanying drawings are written in parentheses, but this invention is not limited to the embodiments as shown in the drawings.

### BRIEF DESCRIPTION OF THE DRAWINGS

FIG. 1 is a cross-sectional view showing a speaker according to a first embodiment of the present invention.

FIG. 2 is a perspective view showing the speaker according to the first embodiment of the invention.

FIG. 3 is a graph showing the relation of input and output of energy Q, surface temperature T and generated sound wave P with respect to the temporal change of the alternating current I, when an AC electric field is applied to an exothermic electrode 3.

FIG. 4 is a graph showing a frequency characteristic of the speaker according to the first embodiment of the invention.

FIGS. 5A to 5D are views showing a manufacturing process for the speaker according to the first embodiment of the invention, in which

FIG. 5A is a view showing a state where an ohmic electrode is formed,

FIG. 5B is a view showing an anodization process,

FIG. 5C is a view showing a quick thermal oxidation process, and

FIG. 5D is a view showing a state where the exothermic electrode is formed.

FIG. 6 is a view showing one example of exothermic electrode that is bent.

FIG. 7 is a cross sectional view showing a speaker according to a second embodiment of the invention.

FIGS. 8A and 8B are views showing a speaker according to a third embodiment of the invention, in which

FIG. 8A is a perspective view showing the speaker according to the third embodiment and

FIG. 8B is a cross sectional view showing the speaker according to the third embodiment of the invention.

FIGS. 9A and 9B are views showing a speaker according to a fourth embodiment of the invention, in which

FIG. 9A is a perspective view showing the speaker according to the fourth embodiment and

FIG. 9B is a cross sectional view showing the speaker according to the fourth embodiment of the invention.

FIGS. 10A and 10B are views showing a speaker according to a fifth embodiment of the invention, in which

FIG. 10A is a perspective view showing the speaker according to the fifth embodiment and

FIG. 10B is a cross sectional view showing the speaker according to the fifth embodiment of the invention.

FIG. 11 is a cross sectional view showing a speaker according to a sixth embodiment of the invention.

FIG. 12 is a graph showing a frequency characteristic of the speaker according to the sixth embodiment of the invention.

### DETAILED DESCRIPTION OF THE PREFERRED EMBODIMENTS

Now, a description will be given in more detail of preferred embodiments of the invention with reference to the accompanying drawings.

### First Embodiment

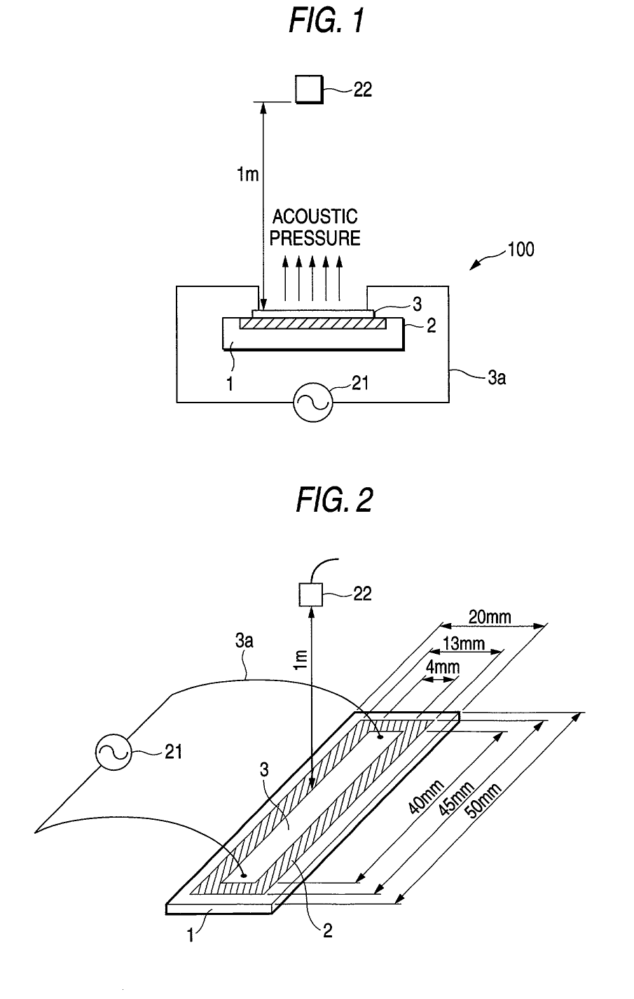

A speaker according to one embodiment of the present invention will be described below with reference to FIGS. 1 to 6. FIG. 1 is a cross-sectional view showing the speaker in the first embodiment, and FIG. 2 is a perspective view showing the speaker in the first embodiment.

As shown in FIGS. 1 and 2, the speaker 100 comprises a silicone wafer 1 as a substrate, a thermal barrier layer 2 of an Si anodized film formed in rectangular shape by anodizing the silicone wafer 1, and an exothermic electrode 3 made of aluminum formed on the thermal barrier layer 2 in smaller rectangular shape than the thermal barrier layer 2.

The shape of the silicone wafer 1 is rectangular, with a long side of 50 mm, a short side of 20 mm, and a thickness of 500 μm. The shape of the thermal barrier layer 2 is rectangular, with a long side of 45 mm, a short side of 13 mm, and a thickness of 20 μm. The shape of the exothermic electrode 3 is rectangular, with a long side of 40 mm, a short side of 4 mm, and a thickness of 330 nm.

The operation of the speaker 100 will be described below. As shown in FIG. 2, an output terminal of an AC signal generator 21 is connected via a lead wire 3a to both ends of the exothermic electrode 3 (on the short side). Then, if an AC electric field is applied, the temperature of the exothermic electrode 3 is varied like the alternating current due to the joule heating. At this time, a heat is hardly conducted to the thermal barrier layer 2 owing to a thermal barrier property of the thermal barrier layer 2, making the efficient heat exchange with the air in the vicinity of the surface of the exothermic electrode 3 to compress or expand the air, thereby producing an acoustic pressure. A heat that cannot be converted into acoustic pressure is radiated from the silicone wafer 1.

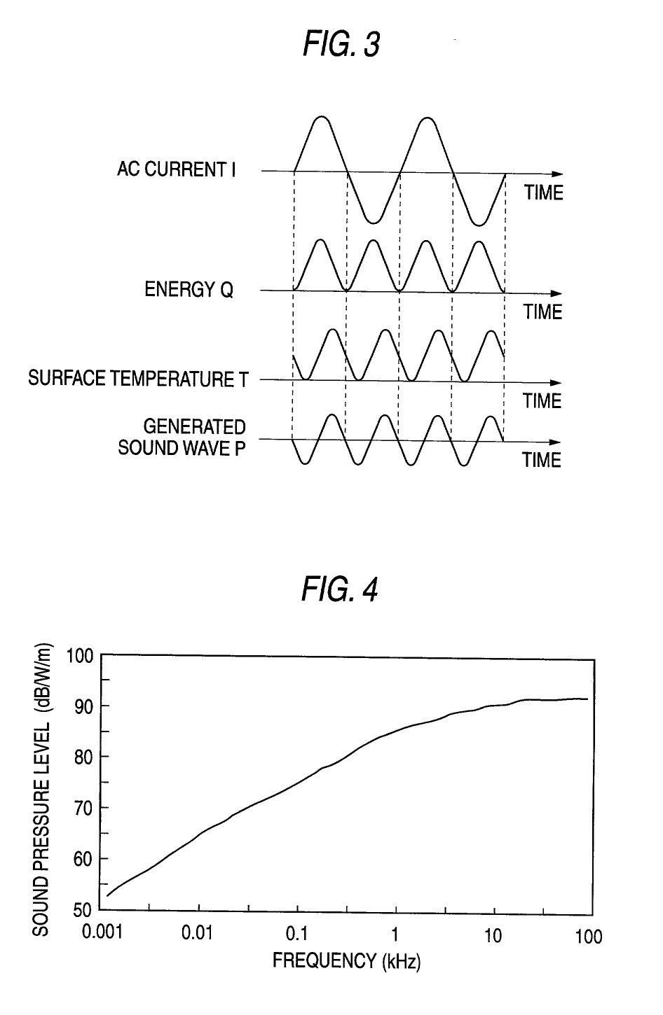

FIG. 3 shows the relation of input or output of energy Q, surface temperature T and generated sound wave P, with respect to the temporal change of the alternating current I, when an AC electric field is applied to the exothermic electrode 3. As shown in FIG. 3, the generated sound wave P has a double frequency of the applied AC frequency. It can be found that the phase of surface temperature T and generated sound wave P is delayed from the energy Q given to the exothermic electrode 3. In the case where the generated sound wave P having the same frequency as the applied AC frequency is desired to obtain, a direct current with half or more the energy of the alternating current may be superposed on the alternating current.

FIG. 4 shows a frequency characteristic of the speaker 100 that is measured by a microphone 22 placed at a position 1 m away from the exothermic electrode 3, as shown in FIGS. 1 and 2. As shown in FIG. 4, a sound pressure level of 90 dB/W/m or greater is obtained in a frequency band of 10 kHz or higher, and the sound pressure level drops with lower frequency.

Since the rating of the AC signal generator 21 is from 0 to 100 kHz, 30 V, and 1 A, no measurements are made in a higher frequency band, although the speaker 100 can produce a sound wave up to Giga-hertz band.

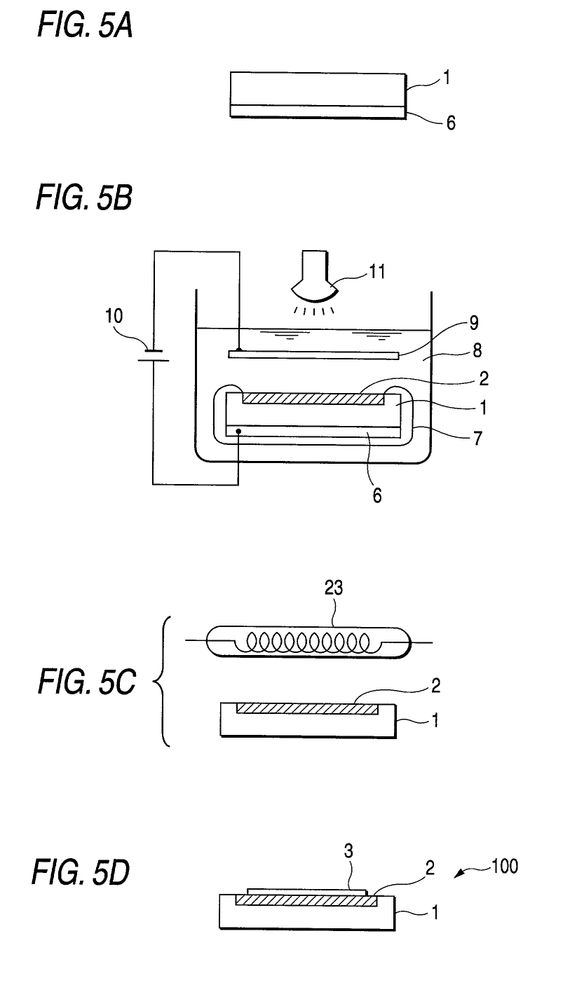

Referring now to FIGS. 5A to 5D, a manufacturing method for the speaker 100 will be described below. FIG. 5A is a view showing a state where an ohmic electrode is formed, FIG. 5B is a view showing a process of anodization, FIG. 5C is a view showing a process of quick thermal oxidation, and FIG. 5D is a view showing a state where the exothermic electrode is formed.

The thermal barrier layer 2 is formed by anodizing a part of the silicone wafer 1. Silicone of the silicone wafer 1 may be monocrystal, polycrystal, or amorphous, and take any crystal orientation. Also, it may be n-type doped, p-type doped, or non-doped.

First of all, an ohmic electrode 6 is formed on one face of the silicone wafer 1 (i.e., a lower face in FIG. 5A) by vacuum deposition or sputtering, as shown in FIG. 5A. Also, an area except for an opening corresponding to a formation area of the thermal barrier layer 2 is masked with a masking material 7, as shown in FIG. 5B. Then, the substrate 1 is immersed in a mixture electrolyte solution 8 of fluoride and ethanol, and a platinum electrode 9 is arranged above the substrate 1 in FIG. 5B. A power source 10 is connected between the ohmic electrode 6 and the platinum electrode 9, and anodization is made at a low current (0.01 to 1 A/cm²), with the ohmic electrode 6 as anode and the platinum electrode 9 as cathode. When the silicone wafer 1 is n-type, anodization is performed by illuminating the substrate 1 with a lamp 11 to supply holes.

The thermal barrier layer 2 formed by anodization becomes porous and is formed with micro pores having a diameter of about 2 to 100 nm, when silicone of the silicone wafer 1 is n-type. The thermal barrier layer 2 has crystal lattice segmented and nanocrystalized, when silicone of the silicone wafer 1 is p-type. Further, holes that are carriers are consumed to make a depletion layer. In either case, the thermal barrier layer 2 can have a quite small thermal conductivity and a large electrical resistance. Then, the substrate 1 is taken out of the mixture electrolyte solution 8, and the masking material 7 and the ohmic electrode 6 are removed.

In order to further enhance the characteristic of the thermal barrier layer 2, the thermal barrier layer 2 may be heated by an infrared ray lamp 23 to make a quick thermal oxidation, as shown in FIG. 5C. In either case where silicone is n-type or p-type, the thermal barrier layer 2 that is an anodized layer has Si and SiOx mixed, but this ratio is adjusted through the quick thermal oxidation process, so that the optimal state can be obtained.

Lastly, the exothermic electrode 3 is formed by vacuum deposition or sputtering to fabricate the speaker 100, as shown in FIG. 5D.

In the above embodiment, the silicone wafer is used, and anodized to form the thermal barrier layer, but instead of the silicone wafer, a substrate made of metal, alloy, or semiconductor that can be anodized may be employed.

Also, instead of forming the thermal barrier layer by anodizing the substrate, the thermal barrier layer may be formed by using the substrate made of metal, alloy or semiconductor, and laying down derivative, metal oxide, metal nitride, ceramic on the substrate by vacuum deposition, sputtering or CVD. The thermal barrier layer can be formed by coating a paste or suspension of derivative, metal oxide, metal nitride, or ceramics on the substrate by screen printing or spin coat, and then sintered.

In the above embodiment, the substrate uses silicone as a material and the exothermic electrode uses aluminum as a material, but materials usable for the substrate or the exothermic electrode include simple substances of metal or its compound, such as Cu, Cr, Pt, Au, W, Ru, Ir, Al, Sc, Ti, V, Mn, Fe, Co, Ni, Zn, Ga, Y, Zr, Nb, Mo, Tc, Rh, Pd, Ag, Cd, Ln, Sn, Ta, Re, Os, Tl, Pb, La, Ce, Pr, Nd, Pm, Sm, Eu, Gd, Tb, Dy, Ho, Er, Tm, Yb, and Lu. Also, the substrate or the exothermic electrode may be formed by laying down the metal or its compound as above cited.

Also, in the case where the thermal barrier material is formed by sputtering or CVD, examples of usable material include metal oxides such as SiOx, LiOx, LiNx, NaOx, Kox, RbOx, CsOx, BeOx, MgOx, MgNx, CaOx, CaNx, SrOx, BaOx, ScOx, YOx, YNx, LaOx, LaNx, CeOx, PrOx, NdOx, SmOx, EuOx, GdOx, TbOx, DyOx, HoOx, ErOx, TmOx, YbOx, LuOx, TiOx, TiNx, ZrOx, ZrNx, HfOx, HfNx, ThOx, VOx, VNx, NbOx, TaOx, TaNx, CrOx, CrNx, MoOx, MoNx, WOx, WNx, MnOx, ReOx, FeOx, FeNx, RuOx, OsOx, CoOx, RhOx, IrOx, NiOx, PbOx, PtOx, CuOx, CuNx, AgOx, AuOx, ZnOx, CdOx, HgOx, BOx, BNx, AlOx, AlNx, GaOx, GaNx, InOx, TiOx, TiNx, SiNx, GeOx, SnOx, PbOx, POx, PNx, AsOx, SbOx, SeOx, and TeOx, metal double oxides such as LiAlO₂, Li₂SiO₃, Li₂TiO₃, Na₂Al₂₂O₃₄, NaFeO₂, Na₄SiO₄, K₂SiO₃, K₂TiO₃, K₂WO₄, Rb₂CrO₄, Cs₂CrO₄, MgAl₂O₄, MgFe₂O₄, MgTiO₃, CaTiO₃, CaWO₄, CaZrO₃, SrFe₁₂O₁₉, SrTiO₃, SrZrO₃, BaAl₂O₄, BaFe₁₂O₁₉, BaTiO₃, Y₃A₁₅O₁₂, Y₃Fe₅O₁₂, LaFeO₃, La₃Fe₅O₁₂, La₂Ti₂O₇, CeSnO₄, CeTiO₄, Sm₃Fe₅O₁₂, EuFeO₃, Eu₃Fe₅O₁₂, GdFeO₃, Gd₃Fe₅O₁₂, DyFeO₃, Dy₃Fe₅O₁₂, HoFeO₃, Ho₃Fe₅O₁₂, ErFeO₃, Er₃Fe₅O₁₂, Tm₃Fe₅O₁₂, LuFeO₃, Lu₃Fe₅O₁₂, NiTiO₃, Al₂TiO₃, FeTiO₃, BaZrO₃, LiZrO₃, MgZrO₃, HfTiO₄, NH₄VO₃, AgVO₃, LiVO₃, BaNb₂O₆, NaNbO₃, SrNb₂O₆, KTaO₃, NaTaO₃, SrTa₂O₆, CuCr₂O₄, Ag₂CrO₄, BaCrO₄, K₂MoO₄, Na₂MoO₄, NiMoO₄, BaWO₄, Na₂WO₄, SrWO₄, MnCr₂O₄, MnFe₂O₄, MnTiO₃, MnWO₄, CoFe₂O₄, ZnFe₂O₄, FeWO₄, CoMoO₄, CuTiO₃, CuWO₄, Ag₂MoO₄, Ag₂WO₄, ZnAl₂O₄, ZnMoO₄, ZnWO₄, CdSnO₃, CdTiO₃, CdMoO₄, CdWO₄, NaAlO₂, MgAl₂O₄, SrAl₂O₄, Gd₃Ga₅O₁₂, InFeO₃, MgIn₂O₄, Al₂TiO₄, FeTiO₃, MgTiO₃, NaSiO₃, CaSiO₃, ZrSiO₄, K₂GeO₃, Li₂GeO₃, Na₂GeO₃, Bi₂Sn₃O₉, MgSnO₃, SrSnO₃, PbSiO₃, PbMoO₄, PbTiO₃, SnO₂·Sb₂O₃, CuSeO₄, Na₂SeO₃, ZnSeO₃, K₂TeO₃, K₂TeO₄, Na₂TeO₃, and Na₂TeO₄, sulfides such as FeS, Al₂S₃, MgS, and ZnS, and fluorides such as LiF, MgF₂, and SmF₃, chlorides such as HgCl, FeCl₂, and CrCl₃, bromides such as AgBr, CuBr, and MnBr₂, iodides such as PbI₂, CuI and FeI₂, and metal oxide nitrides such as SiAlON.

The speaker 100 of this embodiment can be easily handled, because the exothermic electrode 3 is secured to the silicone wafer 1, and can produce a great volume of sound by inputting a large power into the exothermic electrode 3 because the heat not converted into sound wave is radiated via the silicone wafer 1. Also, owing to the use of the Joule heating, it is possible to obtain an essentially high acoustic conversion efficiency and a broad frequency band characteristic. Further, the speaker 1 is small and light, and of the thin type, whereby the entire apparatus can be reduced in size, weight and thickness as compared to the conventional speaker using a diaphragm.

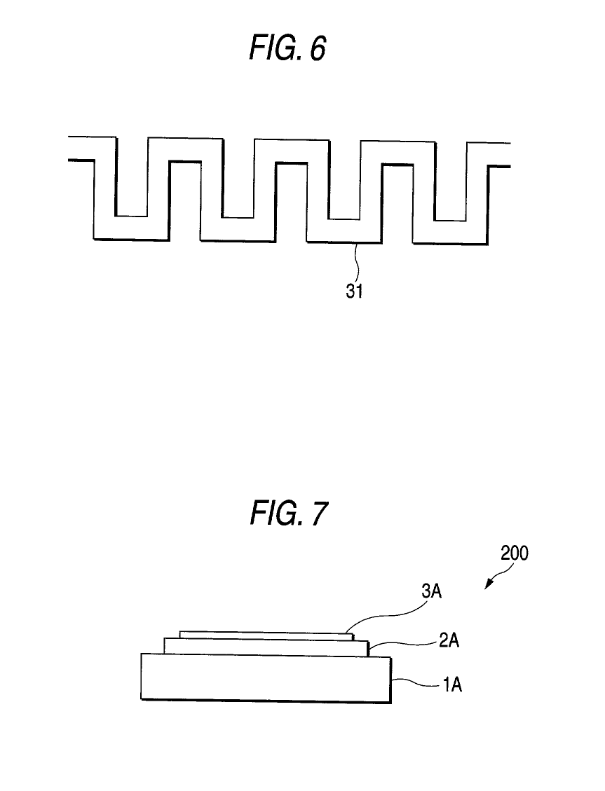

In the above embodiment, the exothermic electrode is formed in rectangular shape, but the exothermic electrode 31 may be formed in bent shape, as shown in FIG. 6. By changing the shape of the exothermic electrode in this manner, the impedance of the exothermic electrode can be controlled. Also, a plurality of exothermic electrodes maybe provided, and driven in series or parallel.

The shape of the substrate in the speaker of this invention is not limited. For example, the substrate may take a shape like a primary curved surface, paraboloid, dome, sphere, or Rugby ball. The shape of the exothermic electrode may be changed in accordance with the shape of the substrate to control the directivity of the generated sound wave.

### Second Embodiment

Referring to FIG. 7, a speaker according to a second embodiment of the invention will be described below. FIG. 7 is a cross-sectional view showing the speaker of the second embodiment.

Though in the first embodiment, the thermal barrier layer 2 is formed by anodizing a part of the silicone wafer 1, a thermal barrier layer 2A of the speaker 200 in the second embodiment is formed on a substrate 1A, as shown in FIG. 6. The thermal barrier layer 2A can be formed by laying down derivative, metal oxide, metal nitride, or ceramics on the substrate 1A by sputtering or CVD. For example, the thermal barrier layer 2A can be formed by coating a paste or suspension of derivative, metal oxide, metal nitride, or ceramics on the substrate 1A by screen printing or spin coat, and then sintered. Further, an exothermic electrode 3A is formed on the thermal barrier layer 2A.

Note that the materials of the substrate 1A, the thermal barrier layer 2A and the exothermic electrode 3A may be those listed in the first embodiment.

The shape of the exothermic electrode may be arbitrary. Also, a plurality of exothermic electrodes may be provided, and driven in series or parallel.

### Third Embodiment

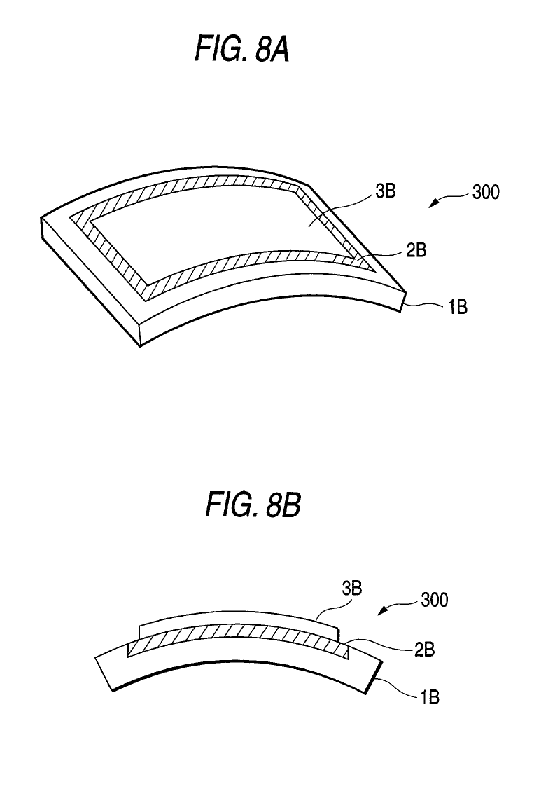

Referring to FIGS. 8A and 8B, a speaker according to a third embodiment of the invention will be described below. FIG. 8A is a perspective view showing the speaker in the third embodiment, and FIG. 8B is a cross-sectional view showing the speaker of the third embodiment.

The speaker 300 of this embodiment comprises a substrate 1B of curved shape, as shown in FIG. 8A and 8B. A thermal barrier layer 2B composed of an anodized film is formed on a part of the substrate 1B, and an exothermic electrode 3B is formed on the thermal barrier layer 2B. The thermal barrier layer 2B and the exothermic electrode 3B are curved according to a surface configuration of the substrate 1B constituting a primary curved face. By changing the shape of the exothermic electrode according to the shape of the substrate 1B in this way, the directivity of the generated sound wave that is different from the exothermic electrode formed in planar shape can be obtained.

Note that the materials of the substrate 1B, the thermal barrier layer 2B and the exothermic electrode 3B may be those listed in the first embodiment.

The thermal barrier layer may be formed on the substrate in the same manner as in the second embodiment.

The shape of the exothermic electrode may be arbitrary. Also, a plurality of exothermic electrodes may be provided, and driven in series or parallel.

### Fourth Embodiment

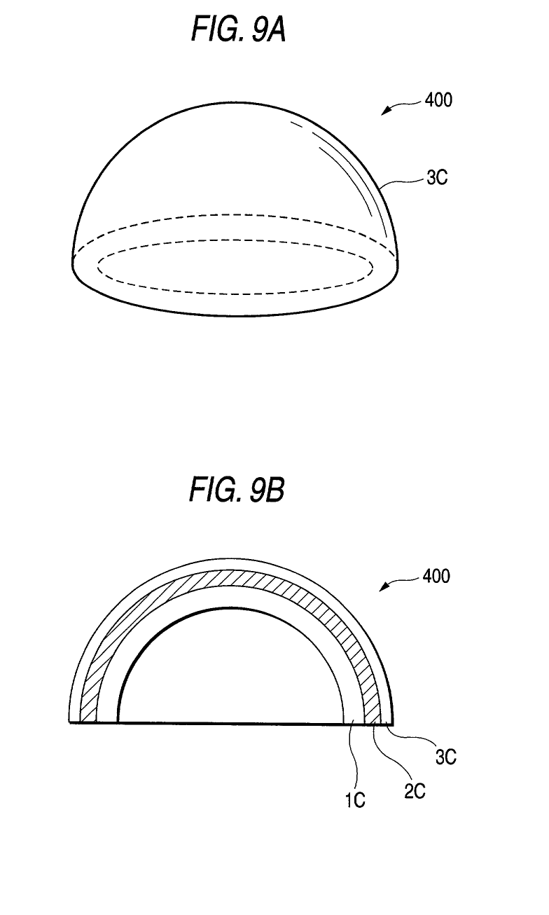

Referring to FIGS. 9A and 9B, a speaker according to a fourth embodiment of the invention will be described below. FIG. 9A is a perspective view showing the speaker in the fourth embodiment, and FIG. 9B is a cross-sectional view showing the speaker of the fourth embodiment.

The speaker 400 of this embodiment comprises a substrate 1C of hemispherical surface shape, as shown in FIGS. 9A and 9B. A thermal barrier layer 2C is formed on the outer surface of the substrate 1C by anodizing the substrate 1C, and an exothermic electrode 3C is formed on the outer surface of the thermal barrier layer 2C. The thermal barrier layer 2C and the exothermic electrode 3C are curved according to a surface configuration of the substrate 1C constituting a part of sphere. In this embodiment, the exothermic electrode 3C is formed in a shape constituting a part of sphere to widen the directivity of generated sound wave.

Note that the materials of the substrate 1C, the thermal barrier layer 2C and the exothermic electrode 3C may be those listed in the first embodiment.

The thermal barrier layer may be formed on the substrate in the same manner as in the second embodiment.

The shape of the exothermic electrode may be arbitrary. Also, a plurality of exothermic electrodes may be provided, and driven in series or parallel.

### Fifth Embodiment

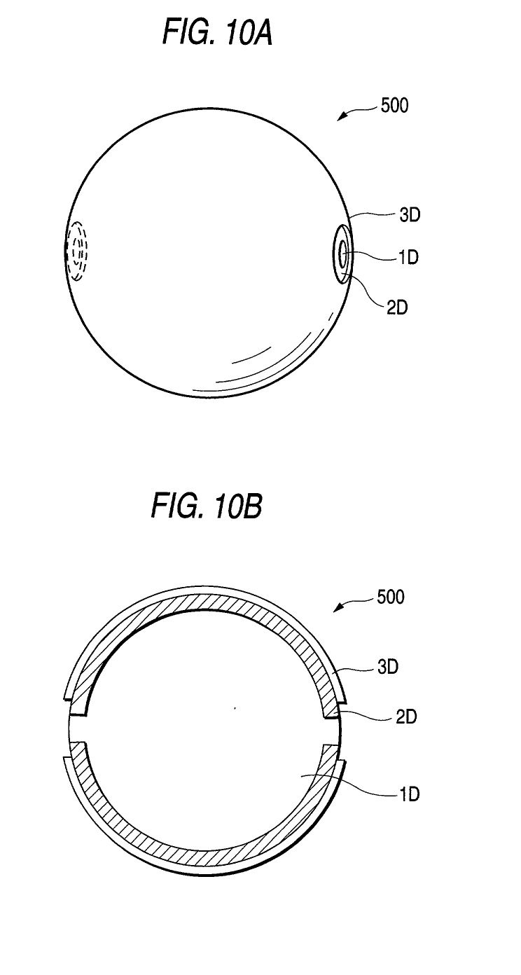

Referring to FIGS. 10A and 10B, a speaker according to a fifth embodiment of the invention will be described below. FIG. 10A is a perspective view showing the speaker in the fifth embodiment, and FIG. 10B is a cross-sectional view showing the speaker of the fifth embodiment.

The speaker 500 of this embodiment comprises a substrate 1D of spherical shape, as shown in FIGS. 10A and 10B. A thermal barrier layer 2D is formed on the outer surface of a base substance 1D by anodizing a part of the base substance 1D, and an exothermic electrode 3D is formed on the outer surface of the thermal barrier layer 2D. In this embodiment, the exothermic electrode 3D is formed according to a spherical shape, whereby the speaker has a non-directivity of radiating sound wave uniformly in substantially all directions.

The thermal barrier layer may be formed on the substrate in the same manner as in the second embodiment.

Note that the materials of the base substance 1D, the thermal barrier layer 2D and the exothermic electrode 3D may be those listed in the first embodiment.

The shape of the exothermic electrode may be arbitrary. Also, a plurality of exothermic electrodes may be provided, and driven in series or parallel.

### Sixth Embodiment

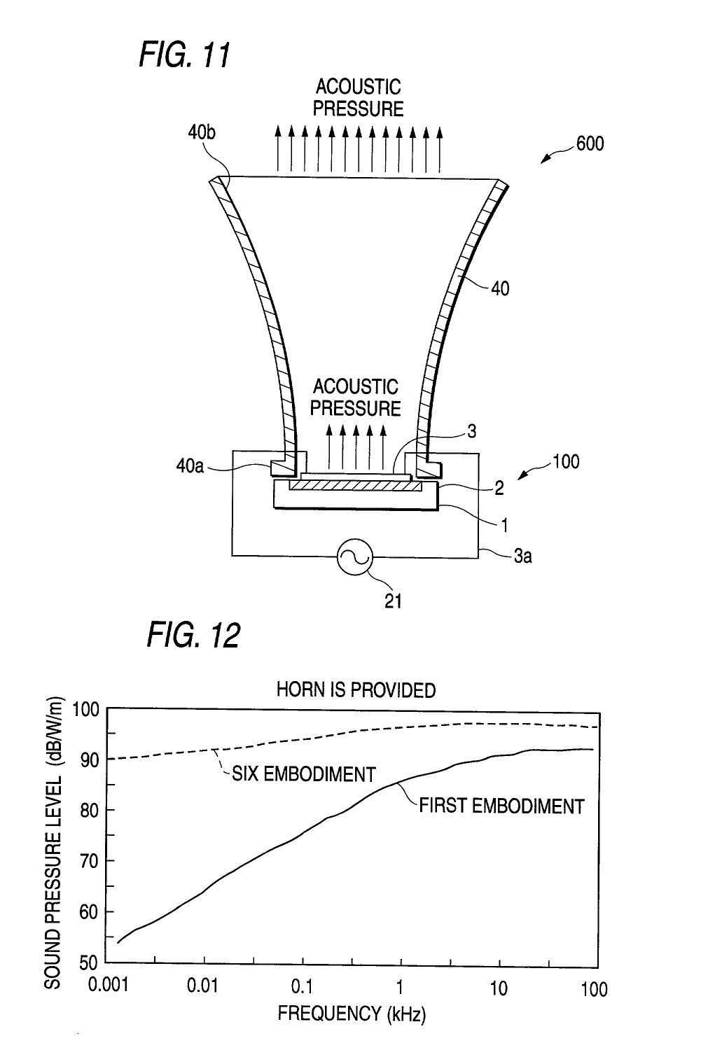

Referring to FIGS. 11 and 12, a speaker according to a sixth embodiment of the invention will be described below. FIG. 11 is a cross-sectional view showing the speaker of the sixth embodiment, and FIG. 12 is a graph showing a frequency characteristic for the speaker of the sixth embodiment.

As shown in FIG. 11, the speaker 600 of the sixth embodiment has an acoustic horn 40 added to the speaker 100 of the first embodiment. The acoustic horn 40 presents a shape of sound path enlarging in section from a throat portion 40a positioned near the exothermic electrode 3 to an opening portion 40b.

As shown in FIG. 12, the speaker 600 of the sixth embodiment has a higher sound pressure level than the speaker 100 of the first embodiment. The speaker 600 that is more efficient particularly in a low frequency band approaches a flat frequency characteristic as a whole. The speaker 600 has a sound pressure level of 95 dB/W/mor greater at 1 kHz, 10 kHz and 100 kHz, 90 dB/W/m or greater at 10 Hz and 100 Hz, and a characteristic of quite wide band, as shown in FIG. 12.

Note that the speaker can be modified in various ways as described in the first embodiment.

What is claimd is:

1. A speaker with the joule heating, comprising:
a substrate;
a thermal barrier layer formed on said substrate; and
an exothermic electrode formed on said thermal barrier layer.

2. The speaker according to claim 1, wherein said thermal barrier layer is formed by anodizing a part of said substrate.

3. The speaker according to claim 1, wherein said thermal barrier layer is formed by supplying a material making up said thermal barrier layer on said substrate.

4. The speaker according to claim 1, wherein said substrate is made of silicone.

5. The speaker according to claim 1, further comprising an acoustic horn for transmitting a sound wave arising in the vicinity of said exothermic electrode.

6. The speaker according to claim 1, wherein the surface of said exothermic electrode is formed in a planar shape.

7. The speaker according to claim 1, wherein the surface of said exothermic electrode is formed in a curved shape.

8. The speaker according to claim 1, wherein the surface of said exothermic electrode is formed in a shape of constituting at least a part of sphere.
